(19) United States
(12) Patent Application Publication
(10) Pub. No.: US 2026/0135464 A1
(43) Pub. Date: May 14, 2026

(54) HYBRID SWITCHING CONVERTER WITH SINGLE INDUCTOR AND MULTIPLE OUTPUTS AND CONTROL METHOD THEREOF

(71) Applicant: Richtek Technology Corporation, Zhubei City (TW)

(72) Inventors: Kuo-Chi Liu, Hsinchu (TW); Chih-Hua Hou, Hsinchu (TW)

(21) Appl. No.: 19/234,656

(22) Filed: Jun. 11, 2025

Related U.S. Application Data
(60) Provisional application No. 63/719,702, filed on Nov. 13, 2024.

(30) Foreign Application Priority Data
Mar. 17, 2025 (TW) 114109828

(51) Int. Cl. H02M 1/00; H02M 3/07; H02M 3/156

(52) U.S. Cl. CPC H02M 1/0095; H02M 1/0009; H02M 1/0058; H02M 1/009; H02M 3/07; H02M 3/156

(57) ABSTRACT

A hybrid switching converter with a single inductor and multiple outputs is disclosed for converting an input voltage to a first output voltage and a second output voltage. The hybrid switching converter includes a sub-switching converter configured to convert the input voltage to an intermediate voltage, and first and second output switches configured to respectively convert the intermediate voltage to the first and second output voltages. An inductor has one terminal coupled to a switched-capacitor voltage dividing circuit and another terminal coupled to a second voltage. Under different configurations, the inductor is coupled to either a negative terminal or a positive terminal of a first capacitor, thereby converting the first voltage to either half the first voltage and a reference potential, or the first voltage and half the first voltage. The first voltage and the second voltage respectively correspond to one of the input voltage and the intermediate voltage.

### CROSS REFERENCE

The present invention claims priority to provisional application 63/719,702 filed on Nov. 13, 2024, and TW 114109828 filed on Mar. 17, 2025.

### BACKGROUND OF THE INVENTION

### Field of Invention

The present invention relates to a hybrid switching converter with a single inductor and multiple outputs and a control method thereof, and more particularly, to a hybrid switching converter capable of generating multiple output voltages and its control method.

### Description of Related Art

Nowadays, data centers, servers, electric vehicles, and various mobile devices often require power converters with multiple output voltages. Under increasingly stringent spatial and thermal constraints, designing power converters with high power density and high efficiency has become a critical research focus. Traditionally, the common solution involves multiple power converter architectures, with each configured with an independent inductor and switching components to support different outputs.

In prior art, as shown in FIG. 1, a multi-output switching converter 10 provides multiple output voltages through different combinations of switches and inductors. In FIG. 1, the input voltage Vin is simultaneously coupled to two buck converters. Switches Q1 and Q2 and inductor L1 form a first buck converter; switches Q3 and Q4 and inductor L2 form a second buck converter, corresponding to a first output voltage Vout1 and a second output voltage Vout2, respectively. On the input side, input capacitor Cin1 is coupled to the first buck converter input, and input capacitor Cin2 is coupled to the second buck converter input, for filtering input voltage ripple. On the output side, output capacitor Co1 is coupled to the output of the first buck converter to stabilize the first output voltage, and output capacitor Co3 is coupled to the output of the second buck converter to stabilize the second output voltage. Additionally, output capacitor Co2 is coupled to the first output voltage Vout1, and output capacitor Co4 is coupled to the second output voltage Vout2 to further reduce output noise and stabilize the output voltages. Notably, output switch Q5 is coupled between the first buck converter and the first output voltage Vout1 to convert the output of the first buck converter into the first output voltage. Output switch Q6 is coupled between the second buck converter and the second output voltage Vout2 to convert the output of the second buck converter into the second output voltage.

In the multi-output switching converter 10 shown in FIG. 1, each of the switches Q1 to Q4 in each buck converter needs to withstand the maximum value of the input voltage Vin to ensure stable operation. Since the input voltage Vin may be quite high, the voltage rating requirement for switches Q1 to Q4 increases accordingly, which implies higher on-resistance and greater conduction losses for these switches. Moreover, to achieve power conversion under high voltage, conventional buck converters must be equipped with larger inductors L1 and L2 to accommodate the voltage difference between the input voltage Vin and the output voltages Vout1 and Vout2. As a result, the size and cost of inductors L1 and L2 increase, making it difficult to reduce the overall power converter size or improve power density.

Because each output requires an independent buck converter and inductor, this poses significant challenges to system layout and thermal management. In high-temperature environments or limited cooling space, ensuring stability and long-term reliability often requires additional thermal design or higher-spec components, thereby increasing cost and complexity.

For multi-output voltage applications, the conventional approach requires repeatedly using multiple power converters. If a system needs to support multiple different output voltages simultaneously (e.g., USB ports, core voltages, peripheral supply voltages), the number of components and wiring complexity increase significantly, making integration into a monolithic chip or module more difficult.

In view of the foregoing, to address the above issues and simultaneously achieve high density, high efficiency, and ease of integration, the present invention proposes a hybrid switching converter with a single inductor and multiple outputs and a control method thereof. The invention aims to significantly reduce voltage stress on switching devices and reduce inductor requirements while maintaining stable output and high efficiency, thereby enhancing integration and system reliability.

### SUMMARY OF THE INVENTION

From one perspective, the present invention provides a hybrid switching converter with a single inductor and multiple outputs for converting an input voltage to a first output voltage and a second output voltage, comprising: a sub-switching converter configured to convert the input voltage to an intermediate voltage; a first output switch configured to conduct during a first inductor cycle according to a first time-division signal, to convert the intermediate voltage to the first output voltage; and a second output switch configured to conduct during a second inductor cycle according to a second time-division signal, to convert the intermediate voltage to the second output voltage; wherein the sub-switching converter comprises: a switched-capacitor voltage dividing circuit, configured to perform switched-capacitor operation during the first inductor cycle by controlling a plurality of switches according to a first set of pulse-width modulation (PWM) signals, converting a first voltage to a first set voltage having two different voltage levels, and configured to perform switched-capacitor operation during the second inductor cycle by controlling the plurality of switches according to a second set of PWM signals, converting the first voltage to a second set voltage having two different voltage levels; an inductor having a first terminal coupled to the switched-capacitor voltage dividing circuit and a second terminal coupled to a second voltage, wherein, during the first inductor cycle, the first terminal of the inductor switches between the two different voltage levels of the first set voltage according to the first set of PWM signals, and during the second inductor cycle, the first terminal of the inductor switches between the two different voltage levels of the second set voltage according to the second set of PWM signals; and a control circuit configured to generate the first set of PWM signals, the second set of PWM signals, and the first time-division signal and the second time-division signal, to time-divisionally control the plurality of switches, the first output switch, and the second output switch, to periodically magnetize and demagnetize the same inductor during the first inductor cycle and the second inductor cycle, to perform power conversion between the first voltage and the second voltage, and to generate the first output voltage and second output voltage periodically corresponding to the first inductor cycle and second inductor cycle; wherein the first voltage and the second voltage respectively correspond to one of the input voltage and the intermediate voltage; wherein the control circuit is further configured to regulate the first output voltage to a first target voltage based on a first feedback signal related to the first output voltage during the first inductor cycle, and regulate the second output voltage to a second target voltage based on a second feedback signal related to the second output voltage during the second inductor cycle; wherein the hybrid switching converter with a single inductor and multiple outputs operates in a boundary conduction mode (BCM) or a discontinuous conduction mode (DCM) during the first and second inductor cycles; wherein a first configuration of the sub-switching converter refers to the inductor being coupled to a negative terminal of a first capacitor of the switched-capacitor voltage dividing circuit, and a second configuration refers to the inductor being coupled to a positive terminal of the first capacitor; wherein, in the first configuration, the sub-switching converter converts the first voltage to two different voltage levels including half the first voltage and a reference potential, and in the second configuration, the sub-switching converter converts the first voltage to two different voltage levels comprising the first voltage and half the first voltage; wherein, during a charging phase, the first capacitor of the switched-capacitor voltage dividing circuit is coupled in series with a second capacitor between the first voltage and the reference potential, and during a discharging phase, the first capacitor is coupled in parallel with the second capacitor to the reference potential.

From another perspective, the present invention provides a control method for a hybrid switching converter with a single inductor and multiple outputs, comprising: converting an input voltage to an intermediate voltage; conducting a first output switch during a first inductor cycle according to a first time-division signal to convert the intermediate voltage to a first output voltage; and conducting a second output switch during a second inductor cycle according to a second time-division signal to convert the intermediate voltage to a second output voltage; wherein converting the input voltage to the intermediate voltage comprises: performing a switched-capacitor operation during the first inductor cycle by controlling a plurality of switches according to a first set of pulse-width modulation (PWM) signals to convert a first voltage to a first set voltage having two different voltage levels, and performing a switched-capacitor operation during the second inductor cycle by controlling the plurality of switches according to a second set of PWM signals to convert the first voltage to a second set voltage having two different voltage levels; switching a first terminal of an inductor between the two different voltage levels of the first set voltage during the first inductor cycle according to the first set of PWM signals; switching the first terminal of the inductor between the two different voltage levels of the second set voltage during the second inductor cycle according to the second set of PWM signals; coupling the first terminal of the inductor to a negative terminal of a first capacitor to form a first configuration and converting the first voltage to two different voltage levels including half the first voltage and a reference potential during the first inductor cycle or the second inductor cycle; coupling the first terminal of the inductor to a positive terminal of the first capacitor to form a second configuration and converting the first voltage to two different voltage levels comprising the first voltage and half the first voltage during the first inductor cycle or the second inductor cycle; during a charging phase, coupling the first capacitor in series with a second capacitor between the first voltage and the reference potential to store charge; during a discharging phase, coupling the first capacitor in parallel with the second capacitor to the reference potential to release charge; time-divisionally controlling the plurality of switches using the first set of PWM signals and the second set of PWM signals to periodically magnetize and demagnetize the same inductor during the first inductor cycle and the second inductor cycle for performing power conversion between the first voltage and a second voltage; wherein the first voltage and the second voltage respectively correspond to one of the input voltage and the intermediate voltage; time-divisionally controlling the first output switch and the second output switch using the first time-division signal and the second time-division signal to periodically generate the first output voltage and the second output voltage corresponding to the first inductor cycle and the second inductor cycle; and regulating the first output voltage to a first target voltage based on a first feedback signal related to the first output voltage during the first inductor cycle, and regulating the second output voltage to a second target voltage based on a second feedback signal related to the second output voltage during the second inductor cycle; wherein the hybrid switching converter with a single inductor and multiple outputs operates in a boundary conduction mode (BCM) or a discontinuous conduction mode (DCM) during the first inductor cycle and the second inductor cycle.

In one embodiment, the switched-capacitor voltage dividing circuit reaches a capacitor balance state in each first inductor cycle and each second inductor cycle.

In one embodiment, the control circuit includes: a first error amplifier configured to amplify a difference between a first feedback signal and a first reference signal to generate a first error amplification signal; a second error amplifier configured to amplify a difference between a second feedback signal and a second reference signal to generate a second error amplification signal; and a modulation circuit configured to generate the first set of PWM signals according to the first error amplification signal during the first inductor cycle, and generate the second set of PWM signals according to the second error amplification signal during the second inductor cycle.

In one embodiment, the control circuit further comprises a current sensing circuit configured to sense an inductor current to generate an inductor current signal, and the modulation circuit is further configured to generate the first set of PWM signals and the second set of PWM signals according to the inductor current signal.

In one embodiment, the current sensing circuit generates a zero current signal when the inductor current reaches a zero current. The control circuit further includes a logic circuit configured to generate the first time-division signal and the second time-division signal based on the zero current signal.

In one embodiment, the control circuit further includes a logic circuit configured to generate the first time-division signal and the second time-division signal based on a clock signal.

In one embodiment, the control circuit further comprises a logic circuit configured to generate a time-division switch control signal, the first time-division signal, and the second time-division signal according to the first error amplification signal, the second error amplification signal, and a clock signal or a zero current signal; wherein the time-division switch control signal, the first time-division signal, and the second time-division signal are triggered by the clock signal or the zero current signal, and the first time-division signal and the second time-division signal are complementary to each other; wherein the logic circuit is further configured to determine whether the hybrid switching converter with a single inductor and multiple outputs enters a skip mode according to a difference between a first output current and a second output current; wherein, in the skip mode, a difference in the number of occurrences of the first inductor cycle and the second inductor cycle within a unit cycle is positively correlated with the difference between the first output current and the second output current.

In one embodiment, the current sensing circuit comprises a sensing resistor and a sensing capacitor connected in series and coupled to the inductor, and the inductor current is sensed based on a voltage across the sensing capacitor to generate the inductor current signal, wherein a time constant of the sensing resistor and the sensing capacitor matches a time constant of the inductor and a DC resistance of the inductor.

In one embodiment, the power conversion between the first voltage and the second voltage is a boost conversion or a buck conversion.

In one embodiment, when the switched-capacitor voltage dividing circuit and the inductor are configured in a buck configuration, the sub-switching converter further comprises a boost switch coupled between the second terminal of the inductor and a reference potential, such that the hybrid switching converter with a single inductor and multiple outputs operates in either a boost conversion or a buck conversion according to the first target voltage or the second target voltage.

In one embodiment, the first set of PWM signals determines a duty ratio of switching between the two different voltage levels of the first set voltage at the first terminal of the inductor, and the second set of PWM signals determines a duty ratio of switching between the two different voltage levels of the second set voltage at the first terminal of the inductor.

In one embodiment, an initial point of a ramp signal is triggered at the end of each first inductor cycle, and another initial point of the ramp signal is triggered at the end of each second inductor cycle; wherein the modulation circuit compares the ramp signal with the first error amplification signal during the first inductor cycle to generate the first set of PWM signals; wherein the modulation circuit compares the ramp signal with the second error amplification signal during the second inductor cycle to generate the second set of PWM signals; wherein the first inductor cycle and the second inductor cycle are arranged alternately and repeated periodically in sequence.

Compared to the prior art, the present invention provides significant improvements, particularly in reducing system size, enhancing efficiency, and increasing power density. First, unlike traditional designs that require multiple buck converters—each output voltage being supported by its own inductor and switching elements—the proposed single-inductor architecture supports multiple output voltages, thereby simplifying circuit design and substantially reducing the number of components used. This innovation increases overall system integration and saves board space. The single-inductor structure also leads to a dramatic reduction in inductor size, which minimizes volume and manufacturing cost, and simplifies both the design and maintenance of the system. Furthermore, the switched-capacitor voltage dividing circuit reduces voltage stress across the inductor, which not only lowers the voltage rating requirement for switching elements, but also extends system lifespan. As a result, low-voltage-rated switches may be selected, contributing to cost and size reduction. Compared to the high switching losses in conventional systems, the present invention also improves energy efficiency. It adopts zero-current switching (ZCS) to enable transitions at nearly zero current, significantly reducing switching loss and electromagnetic interference (EMI), and enhancing overall performance. Additionally, the system no longer requires extra circuitry to balance capacitor voltage, which is often a challenge in multi-capacitor designs. This simplifies control logic, enhances stability and reliability, and reduces design complexity. Overall, the invention provides a compact, efficient, and easy-to-implement power solution that overcomes limitations of conventional approaches.

In contrast to conventional multi-channel buck converters that require individual inductors for each output, the present invention supports multiple outputs with a single inductor. By integrating the inductor resource with a switched-capacitor architecture, the design reduces the number of bulky inductors and avoids wasted layout space caused by stacking multiple magnetic components. Fewer components also lead to reduced mutual interference, thus improving overall design efficiency and system reliability.

Regarding power density, the use of only one inductor and the ability to reduce inductance value contribute to a significant reduction in converter volume. This directly enhances power density. Moreover, the use of an efficient switched-capacitor transfer mechanism minimizes conduction and switching losses during energy transfer, further improving system efficiency. As higher efficiency generates less heat, thermal design is simplified, improving system reliability and portability.

In terms of switching element design, the hybrid switching converter utilizes flying-capacitor or voltage-dividing operations to significantly reduce voltage stress across the switches. This allows for the use of lower-voltage-rated switches, which lowers component cost and volume. Combined with soft-switching techniques such as zero-current switching (ZCS) or zero-voltage switching (ZVS), switching loss and EMI are further reduced, contributing to higher efficiency and better noise suppression.

Furthermore, the proposed architecture adopts a switched-capacitor voltage dividing circuit consisting of two capacitors. The switching operation achieves automatic dynamic charge balancing between capacitors during every inductor cycle—that is, during each magnetization and demagnetization operation of the inductor—thus drastically shortening capacitor balancing time. With all these features, the invention not only realizes higher power density and efficiency but also simplifies system complexity, delivering superior overall benefits for multi-output power applications.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a schematic diagram illustrating a conventional switching converter with multiple outputs.

FIGS. 2A and 2B are schematic diagrams illustrating a hybrid switching converter with a single inductor and multiple outputs according to one embodiment of the present invention.

FIGS. 2C and 2D are schematic diagrams illustrating a switched-capacitor voltage dividing circuit of the hybrid switching converter during a charging phase and a discharging phase, respectively, according to one embodiment of the present invention.

FIG. 3 is a schematic diagram illustrating a more detailed example of a sub-switching converter of the hybrid switching converter with a single inductor and multiple outputs shown in FIGS. 2A to 2D.

FIG. 4 is a schematic diagram illustrating a more detailed example of a control circuit of the hybrid switching converter with a single inductor and multiple outputs shown in FIGS. 2A to 2D.

FIG. 5 is a schematic diagram illustrating another more detailed example of the control circuit of the hybrid switching converter with a single inductor and multiple outputs shown in FIGS. 2A to 2D.

FIG. 6 is a schematic diagram illustrating a ramp signal generation circuit of the control circuit according to one embodiment of the present invention.

FIG. 7 is a schematic diagram illustrating yet another more detailed example of the control circuit of the hybrid switching converter with a single inductor and multiple outputs shown in FIGS. 2A to 2D.

FIG. 8 is a schematic diagram illustrating a logic circuit of the control circuit according to one embodiment of the present invention.

FIG. 9 is a schematic diagram illustrating a current sensing circuit of the control circuit according to one embodiment of the present invention.

FIG. 10 is a schematic diagram illustrating waveforms of related signals in the hybrid switching converter with a single inductor and multiple outputs according to one embodiment of the present invention.

FIG. 11 is a schematic diagram illustrating additional waveforms of related signals in the hybrid switching converter with a single inductor and multiple outputs according to one embodiment of the present invention.

FIG. 12 is a schematic diagram illustrating another more detailed example of the sub-switching converter of the hybrid switching converter with a single inductor and multiple outputs shown in FIGS. 2A to 2D.

FIG. 13A is a schematic diagram illustrating a logic circuit according to one embodiment of the present invention.

FIG. 13B is a schematic diagram illustrating a time-division switching control signal Sab under a normal mode of operation of the hybrid switching converter with a single inductor and multiple outputs according to one embodiment of the present invention.

FIG. 13C is a schematic diagram illustrating the time-division switching control signal Sab under a skip mode of operation of the hybrid switching converter with a single inductor and multiple outputs according to one embodiment of the present invention.

FIG. 13D is a schematic diagram illustrating the time-division switching control signal Sab under another skip mode of operation of the hybrid switching converter with a single inductor and multiple outputs according to one embodiment of the present invention.

FIGS. 14A and 14B are schematic diagrams illustrating a first configuration and a second configuration of the switched-capacitor voltage dividing circuit, respectively.

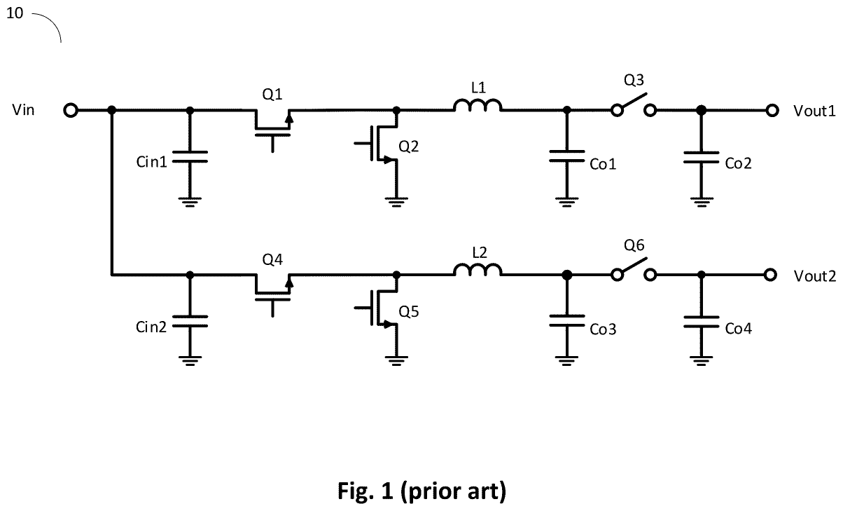

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

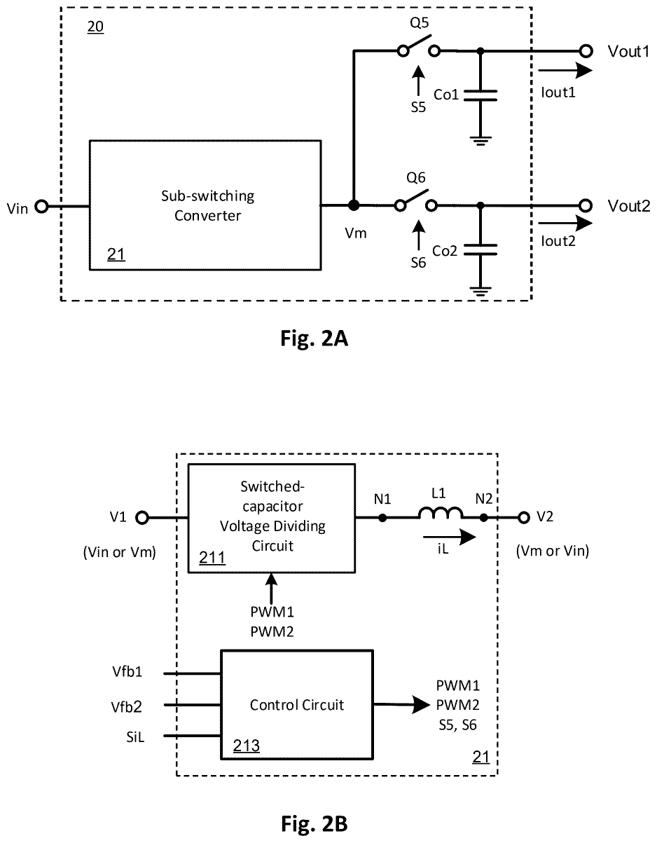

FIGS. 2A and 2B are schematic block diagrams illustrating a hybrid switching converter with a single inductor and multiple outputs according to one embodiment of the present invention. As shown in FIG. 2A, a hybrid switching converter 20 with a single inductor and multiple outputs is configured to convert an input voltage Vin to a first output voltage Vout1 and a second output voltage Vout2, and to accordingly generate a first output current Iout1 and a second output current Iout2. The hybrid switching converter 20 includes a sub-switching converter 21, a first output switch Q5, and a second output switch Q6. The sub-switching converter 21 is configured to convert the input voltage Vin to an intermediate voltage Vm. The first output switch Q5 is coupled between the intermediate voltage Vm and the first output voltage Vout1, and is configured to conduct during a first inductor cycle according to a first time-division signal S5, so as to convert the intermediate voltage Vm to the first output voltage Vout1. The second output switch Q6 is coupled between the intermediate voltage Vm and the second output voltage Vout2, and is configured to conduct during a second inductor cycle according to a second time-division signal S6, so as to convert the intermediate voltage Vm to the second output voltage Vout2.

Referring to FIG. 2B, the sub-switching converter 21 includes a switched-capacitor voltage dividing circuit 211, an inductor L1, and a control circuit 213. During the first inductor cycle, the switched-capacitor voltage dividing circuit 211 performs switched-capacitor operation by controlling a plurality of switches (not shown, described later) according to a first set of pulse-width modulation (PWM) signals PWM1 to convert a first voltage V1 to a first set voltage having two different voltage levels. During the second inductor cycle, the switched-capacitor voltage dividing circuit 211 performs switched-capacitor operation by controlling the plurality of switches (not shown) according to a second set of PWM signals PWM2 to convert the first voltage V1 to a second set voltage having two different voltage levels. The inductor L1 has a first terminal N1 coupled to the switched-capacitor voltage dividing circuit 211 and a second terminal N2 coupled to a second voltage V2. During the first inductor cycle, the first terminal N1 of the inductor L1 switches between the two voltage levels of the first set voltage according to the duty ratio of the first set of PWM signals PWM1. During the second inductor cycle, the first terminal N1 of the inductor L1 switches between the two voltage levels of the second set voltage according to the duty ratio of the second set of PWM signals PWM2. In other words, the duty ratio of PWM1 determines the switching between the two voltage levels of the first set voltage at the first terminal N1 of the inductor L1, and the duty ratio of PWM2 determines the switching between the two voltage levels of the second set voltage. The control circuit 213 is configured to generate the first set of PWM signals PWM1, the second set of PWM signals PWM2, the first time-division signal S5, and the second time-division signal S6 to time-divisionally control the plurality of switches of the switched-capacitor voltage dividing circuit 211, the first output switch Q5, and the second output switch Q6. The control circuit 213 is further configured to periodically magnetize and demagnetize the same inductor L1 during the first inductor cycle and the second inductor cycle, to perform power conversion between the first voltage V1 and the second voltage V2, and to periodically generate the first output voltage Vout1 and the second output voltage Vout2 corresponding to the first and second inductor cycles.

The first voltage V1 and the second voltage V2 respectively correspond to one of the input voltage Vin and the intermediate voltage Vm. In one embodiment, the first voltage V1 is the input voltage Vin and the second voltage V2 is the intermediate voltage Vm. In this case, the switched-capacitor voltage dividing circuit 211 and the inductor L1 are configured in a buck configuration, where the intermediate voltage Vm is lower than the input voltage Vin without requiring additional switching elements. In another embodiment, the first voltage V1 is the intermediate voltage Vm and the second voltage V2 is the input voltage Vin. In this case, the switched-capacitor voltage dividing circuit 211 and the inductor L1 are configured in a boost configuration, where the intermediate voltage Vm is higher than the input voltage Vin.

The control circuit 213 is further configured to regulate the first output voltage Vout1 to a first target voltage during the first inductor cycle based on a first feedback signal Vfb1 related to the first output voltage Vout1, and to regulate the second output voltage Vout2 to a second target voltage during the second inductor cycle based on a second feedback signal Vfb2 related to the second output voltage Vout2. The hybrid switching converter 20 with a single inductor and multiple outputs operates in a boundary conduction mode (BCM) or a discontinuous conduction mode (DCM) during the first and second inductor cycles.

FIGS. 2C and 2D are schematic diagrams illustrating the switched-capacitor voltage dividing circuit of the hybrid switching converter with a single inductor and multiple outputs during a charging phase and a discharging phase, respectively, according to one embodiment of the present invention. For clarity, a plurality of switches in the switched-capacitor voltage dividing circuit are omitted from these figures. These switches configure the first and second capacitors to form the circuits shown in FIGS. 2C and 2D during the respective charging and discharging phases.

As shown in FIG. 2C, during the charging phase, a first capacitor C1 and a second capacitor C2 are connected in series between the first voltage V1 and a reference potential (ground in this embodiment). As shown in FIG. 2D, during the discharging phase, the first capacitor C1 and the second capacitor C2 are connected in parallel, with their negative terminals both coupled to the reference potential.

In addition, a first configuration of the sub-switching converter 21 refers to the inductor L1 being coupled to a negative terminal of the first capacitor C1 of the switched-capacitor voltage dividing circuit 211. That is, as shown in FIGS. 2C and 2D, a single-pole double-throw (SPDT) switch connects the common terminal G to the terminal D2. A second configuration of the sub-switching converter 21 refers to the inductor L1 being coupled to a positive terminal of the first capacitor C1, meaning the SPDT switch connects the common terminal G to the terminal D1. In the first configuration, the first voltage V1 is converted at the common terminal G into two different voltage levels: half the first voltage V1 and the reference potential. That is, the voltage at the common terminal G switches between half the first voltage V1 and the reference potential. In the second configuration, the first voltage V1 is converted at the common terminal G into two different voltage levels: the first voltage V1 and half the first voltage V1, meaning the voltage at the common terminal G switches between the first voltage V1 and half the first voltage V1.

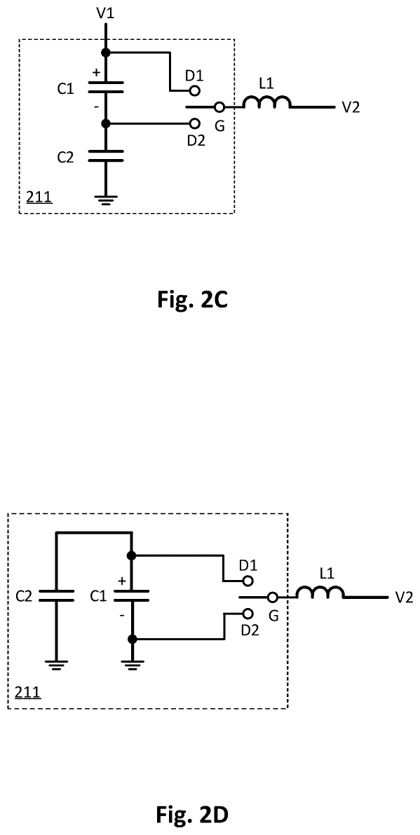

FIG. 3 is a schematic diagram illustrating a more detailed embodiment of the sub-switching converter 21 of the hybrid switching converter 20 with a single inductor and multiple outputs shown in FIGS. 2A to 2D. As shown in FIG. 3, the sub-switching converter 21 includes the switched-capacitor voltage dividing circuit 211, the inductor L1, and the control circuit 213. In this embodiment, for example, the first voltage V1 is the input voltage Vin, and the second voltage V2 is the intermediate voltage Vm. The switched-capacitor voltage dividing circuit 211 and the inductor L1 are configured in a buck configuration, and the sub-switching converter 21 is in the first configuration, i.e., the inductor L1 is coupled to the negative terminal of the first capacitor C1. The switched-capacitor voltage dividing circuit 211 includes switches Q1, Q2, Q3, Q4, the first capacitor C1, and the second capacitor C2. The circuit converts the input voltage Vin to a divided voltage having two different voltage levels: half the input voltage Vin and the reference potential. Switches Q1-Q4 are connected in series between the input voltage Vin and the reference potential. The first capacitor C1 is connected in parallel with the series combination of switches Q2 and Q3, and the second capacitor C2 is connected between the node between Q2 and Q3 and the reference potential.

By properly controlling switches Q1 to Q4, the first capacitor C1 is charged to half the input voltage Vin during a charging phase. The first terminal N1 of the inductor L1 thus sees a voltage equal to Vin minus half Vin, i.e., half Vin. During the subsequent discharging phase, the first terminal N1 of the inductor L1 is connected to the reference potential, thereby achieving a two-level voltage waveform consisting of half the input voltage Vin and the reference potential.

In this embodiment, the first set of PWM signals PWM1 refers to pulse-width modulation signals S1 to S4 used in the first inductor cycle, and the second set of PWM signals PWM2 refers to S1 to S4 used in the second inductor cycle. The PWM signals S1-S4 respectively control switches Q1-Q4. In this embodiment, the two voltage levels of the first set voltage are, for example, half the input voltage Vin and the reference potential. Similarly, the two voltage levels of the second set voltage are also half the input voltage Vin and the reference potential. That is, during the first inductor cycle, the first set of PWM signals converts the input voltage Vin to two voltage levels: half the input voltage Vin and the reference potential; during the second inductor cycle, the second set of PWM signals performs the same conversion. The operating details will be described hereinafter.

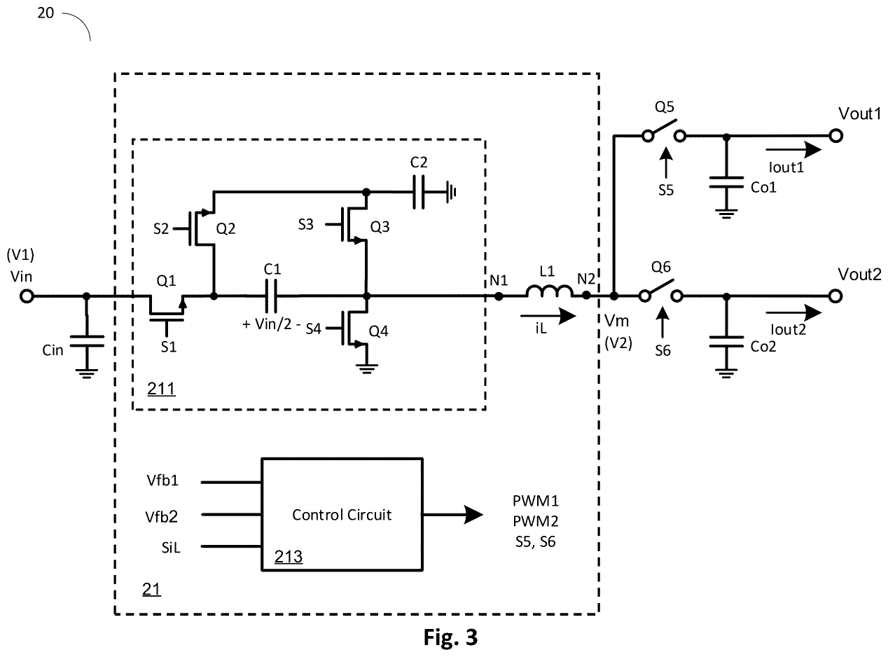

FIG. 4 illustrates a schematic diagram of a specific embodiment of the control circuit 213 in the hybrid switching converter 20 with a single inductor and multiple outputs shown in FIGS. 2A-2D. As shown in FIG. 4, the control circuit 213 includes a first error amplifier EA1, a second error amplifier EA2, and a modulation circuit 2131. The first error amplifier EA1 is configured to amplify the difference between a first feedback signal Vfb1 and a first reference signal Vref1 to generate a first amplified error signal Scom1. The second error amplifier EA2 is configured to amplify the difference between a second feedback signal Vfb2 and a second reference signal Vref2 to generate a second amplified error signal Scom2. The first reference signal Vref1 is associated with a first target voltage of the first output voltage Vout1, and the second reference signal Vref2 is associated with a second target voltage of the second output voltage Vout2.

The modulation circuit 2131 is configured to generate a first set of pulse-width modulation (PWM) signals PWM1 during the first inductor cycle based on the first amplified error signal Scom1, and to generate a second set of PWM signals PWM2 during the second inductor cycle based on the second amplified error signal Scom2. The first PWM signal set PWM1 refers to PWM signals S1-S4 during the first inductor cycle, and the second PWM signal set PWM2 refers to PWM signals S1-S4 during the second inductor cycle.

Please continue referring to FIG. 4. In this embodiment, the modulation circuit 2131 includes a time-division switch SWab, a comparator CP, and a PWM signal generator PWMGen. During the first inductor cycle, the time-division switch SWab connects the first error amplifier EA1 to the comparator CP so that the first amplified error signal Scom1 is transmitted to the comparator CP as an error signal Vcomp to be compared with a ramp signal Vramp. During the second inductor cycle, the time-division switch SWab connects the second error amplifier EA2 to the comparator CP so that the second amplified error signal Scom2 is transmitted to the comparator CP as the error signal Vcomp to be compared with the ramp signal Vramp.

In this embodiment, during the first inductor cycle, the comparator CP compares the first amplified error signal Scom1 with the ramp signal Vramp. The comparison result is processed by the PWM signal generator PWMGen to produce PWM signals S1, S2, S3, and S4 during the first inductor cycle, which form the first PWM signal set PWM1.

In this embodiment, during the second inductor cycle, the comparator CP compares the second amplified error signal Scom2 with the ramp signal Vramp. The comparison result is processed by the PWM signal generator PWMGen to produce PWM signals S1, S2, S3, and S4 during the second inductor cycle, which form the second PWM signal set PWM2.

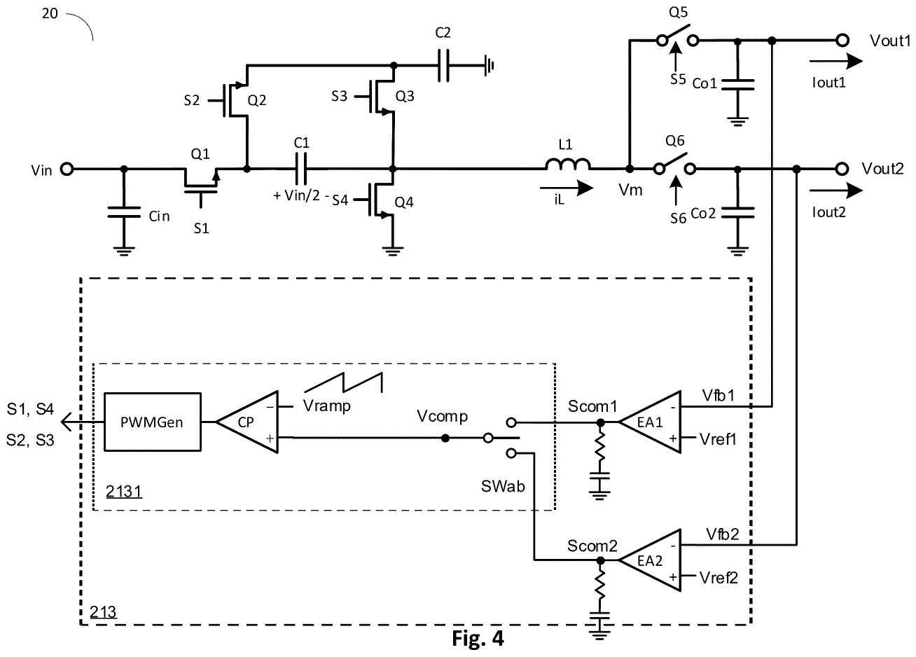

FIG. 5 illustrates another specific embodiment of the control circuit 213 in the hybrid switching converter 20 with a single inductor and multiple outputs shown in FIGS. 2A-2D. The difference between this embodiment and the one shown in FIG. 4 is that the control circuit 213 further includes a current sensing circuit 2132 configured to sense the inductor current iL flowing through the inductor L1 to generate an inductor current signal SiL. The modulation circuit 2131 further generates the first PWM signal set PWM1 and the second PWM signal set PWM2 based on the inductor current signal SiL.

For example, the comparator CP may compare the sum of the inductor current signal SiL and the ramp signal Vramp with the error signal Vcomp to generate PWM signals S1, S2, S3, and S4. Alternatively, the comparator CP may compare the sum of the error signal Vcomp and the inductor current signal SiL with the ramp signal Vramp to generate the PWM signals. As another example, the comparator CP may first compare the error signal Vcomp with the ramp signal Vramp, and then add the result to the inductor current signal SiL to generate the PWM signals.

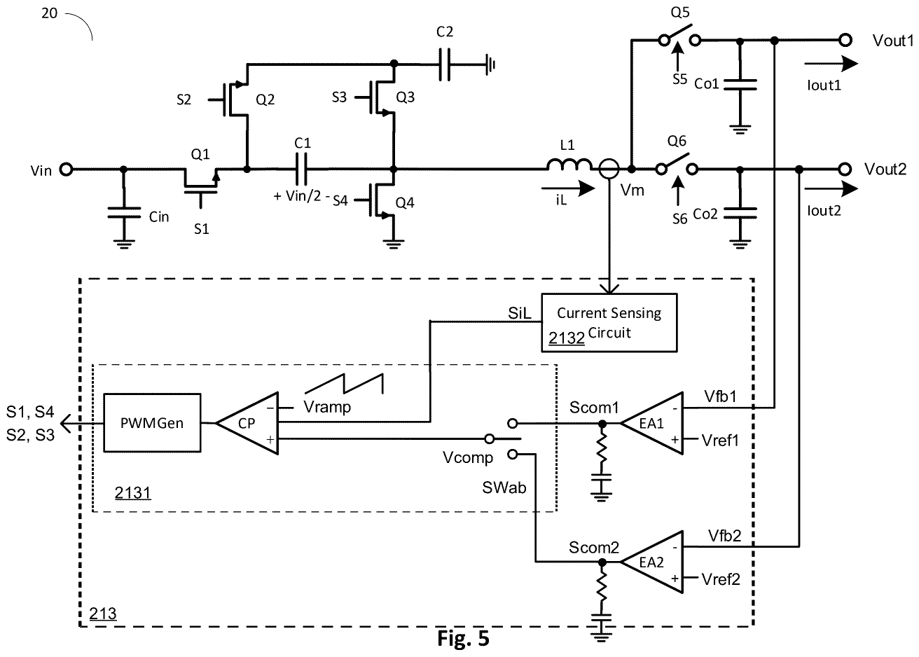

FIG. 6 is a schematic diagram illustrating a ramp signal generator of the control circuit according to one embodiment of the present invention. The control circuit 213, for example, further includes a ramp signal generator 2133. As shown in FIG. 6, the ramp signal generator 2133 includes a logic control circuit 21331, a pulse generator PG, a current source Is, a reset switch Srp, and a capacitor Crp. Under boundary conduction mode (BCM), the logic control circuit 21331 generates a switching clock signal Ck based on a zero-current signal Szc. Under discontinuous conduction mode (DCM), the logic control circuit 21331 generates the switching clock signal Ck based on a clock signal Clk. In one embodiment, the switching clock signal Ck may be a clock signal Clk with a fixed cycle, or a signal determined by the zero-current signal Szc and the control loop. The pulse generator PG generates a trigger signal Stg based on the switching clock signal Ck. The current source Is is coupled to an internal supply voltage Vcc, which is supplied by an internal power source of the circuit.

The reset switch Srp operates based on the trigger signal Stg to control the charging and discharging of the capacitor Crp by the current source Is, thereby generating a ramp signal Vramp across the capacitor Crp. In one embodiment, after the trigger signal Stg is activated, when the ramp signal Vramp is lower than the error signal Vcomp, the comparator CP generates a comparison signal Scp to control the PWM signal generator PWMGen to generate PWM signals S1, S2, S3, and S4.

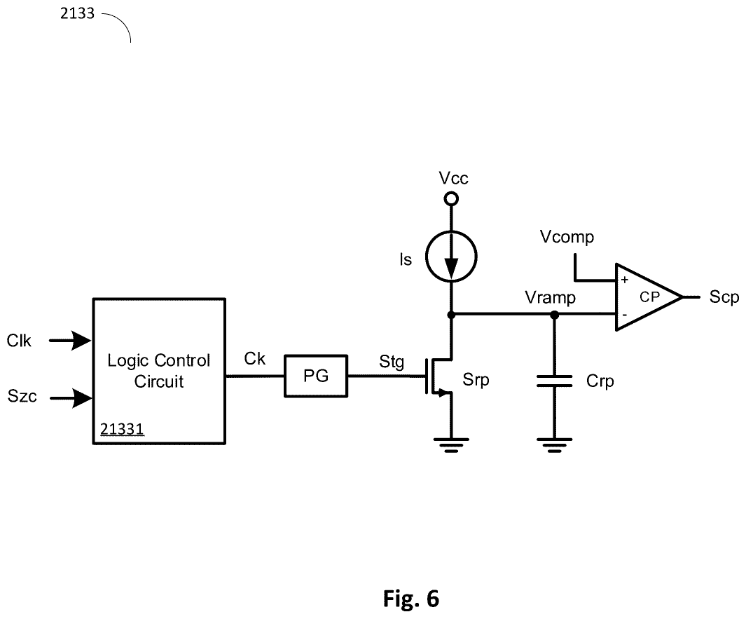

FIG. 7 illustrates yet another specific embodiment of the control circuit 213 in the hybrid switching converter 20 with a single inductor and multiple outputs shown in FIGS. 2A-2D. Compared with the control circuit 213 in FIG. 5, in this embodiment, the current sensing circuit 2132 is further configured to generate a zero-current signal Szc when the inductor current iL is zero. The control circuit 213 further includes a logic circuit 2134 configured to generate a first time-division signal S5, a second time-division signal S6, and a time-division switching control signal Sab based on the zero-current signal Szc. The time-division switching control signal Sab is used to control the time-division switch SWab such that SWab connects the first error amplifier EA1 to the comparator CP during the first inductor cycle, and connects the second error amplifier EA2 to the comparator CP during the second inductor cycle.

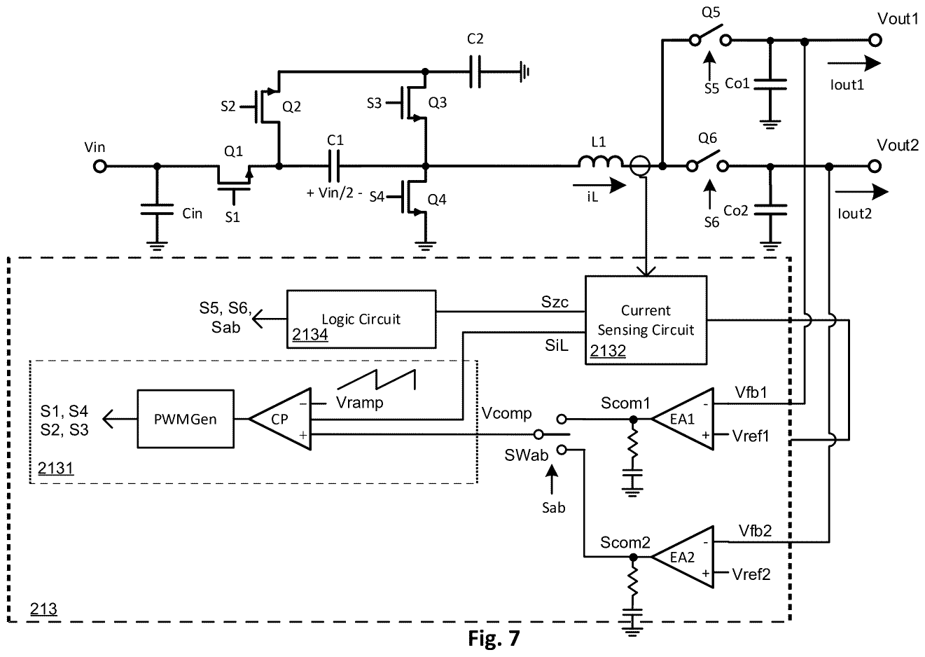

FIG. 8 is a circuit diagram illustrating a logic circuit of the control circuit according to one embodiment of the present invention. Referring to the embodiment shown in FIG. 7, the control circuit 213 further includes a logic circuit 2134. In this embodiment, as shown in FIG. 8, the logic circuit 2134 includes, for example, a D-type flip-flop. The input terminal D of the D-type flip-flop receives an inverted signal from its output terminal Q, and the clock terminal receives either the zero current signal Szc or the clock signal Clk. The internal logic circuit performs state transitions based on predefined trigger conditions and, according to its digital logic operation, respectively generates a first time-division signal S5 and a time-division switch control signal Sab at the output terminal Q, and generates a second time-division signal S6 at the inverted output terminal Q′. The first time-division signal S5 is used to control the first output switch Q5, the time-division switch control signal Sab is used to control the time-division switch SWab, and the second time-division signal S6 is used to control the second output switch Q6. As a result, the two sets of time-division signals (S5 and S6) can alternately control the first and second output switches in a time-multiplexed manner, thereby generating the corresponding first and second output voltages Vout1 and Vout2 during the periodic first and second inductor cycles. In addition to controlling the output switches Q5 and Q6, the time-division switch control signal Sab can also be used to operate the time-division switch SWab as described above.

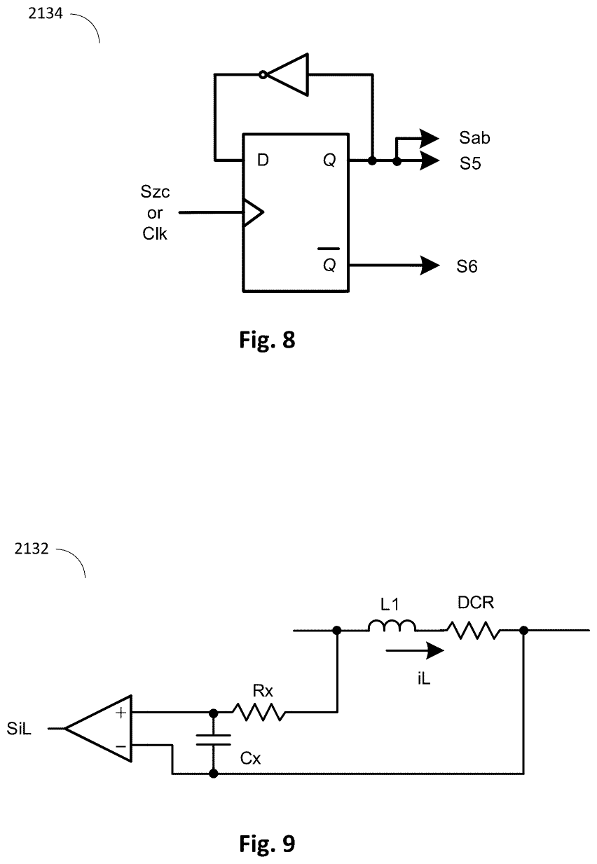

FIG. 9 is a circuit diagram illustrating a current sensing circuit of the control circuit according to one embodiment of the present invention. Referring again to the embodiment shown in FIG. 5, the control circuit 213 further includes a current sensing circuit 2132. In this embodiment, as shown in FIG. 9, the current sensing circuit 2132 includes a sensing resistor Rx and a sensing capacitor Cx, wherein the sensing resistor Rx and the sensing capacitor Cx are connected in series and coupled to the inductor L1. The current of the inductor iL is sensed via the voltage across the sensing capacitor Cx, thereby generating the inductor current signal SiL. The time constant of the sensing resistor Rx and the sensing capacitor Cx matches the time constant of the inductor L1 and its direct current resistance (DCR).

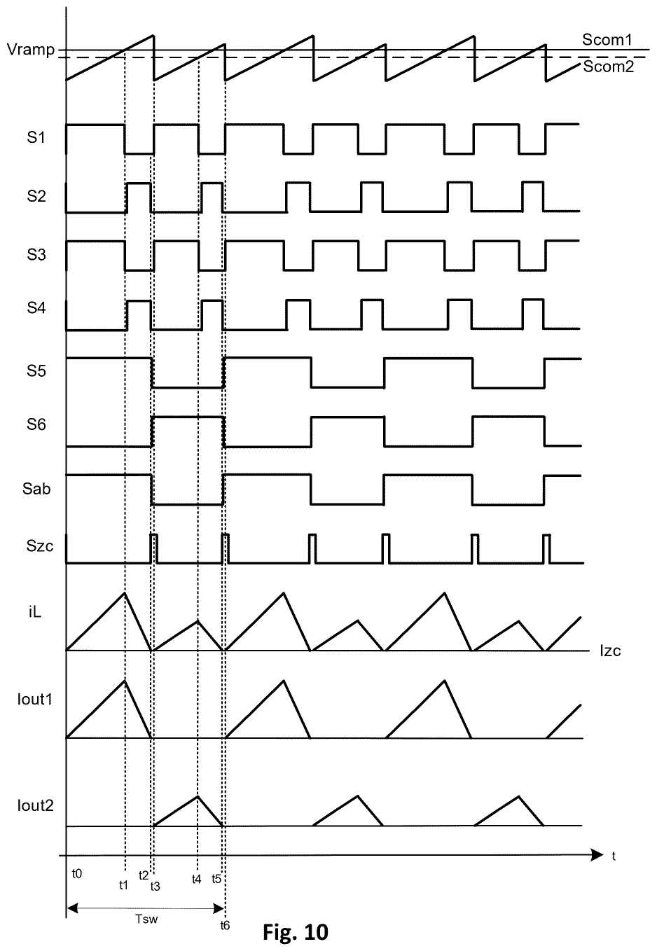

FIG. 10 is a signal waveform diagram illustrating relevant signals of the hybrid switching converter with a single inductor and multiple outputs according to one embodiment of the present invention. The horizontal axis represents time t, and the vertical axis shows the waveform of each corresponding signal. This embodiment takes one periodic first inductor cycle and one second inductor cycle as an example, where a period from time point t0 to time point t6 represents one unit cycle Tsw, including one first inductor cycle and one second inductor cycle. In this embodiment, the hybrid switching converter operates in boundary conduction mode (BCM) during each first inductor cycle and each second inductor cycle. It should be noted that the unit cycle Tsw refers to a complete cycle in which all output switching operations and energy conversions of the hybrid switching converter are completed, and it repeats continuously and periodically during operation.

Between time point t0 and time point t3, the hybrid switching converter with a single inductor and multiple outputs operates in the first inductor cycle. During this period, the time-division switch control signal Sab controls the time-division switch SWab, for example, to a high logic level, so as to electrically connect the first error amplifier EA1 to the comparator CP. Meanwhile, the first time-division signal S5 turns ON the first output switch Q5, and the second time-division signal S6 turns OFF the second output switch Q6. During the interval from time point t0 to time point t1, the first error amplification signal Scom1 is higher than the ramp signal Vramp, causing the pulse-width modulation (PWM) signal S1 to be at a high level, thereby turning ON switch Q1. At the same time, since PWM signal S2 is the inverted signal of PWM signal S1, it is at a low level, so switch Q2 is turned OFF; PWM signal S3, being the inverse of PWM signal S2, is at a high level, turning ON switch Q3; and PWM signal S4, being the inverse of PWM signal S1, is at a low level, turning OFF switch Q4. Therefore, during the time interval from time point t0 to time point t1, switches Q1 and Q3 are ON, and switches Q2 and Q4 are OFF, such that the first capacitor C1 and the second capacitor C2 are electrically connected in series between the input voltage Vin and the ground potential. At this moment, the first capacitor C1 is charged, and the voltage at the first terminal N1 of inductor L1 is half of the input voltage Vin (i.e., the difference between the input voltage Vin and the voltage across the first capacitor C1: Vin−Vin/2). The inductor L1 is magnetized, and the inductor current iL gradually increases. Meanwhile, the first output current Iout1 also gradually increases.

During the interval from time point t1 to time point t2, the first error amplification signal Scom1 is lower than the ramp signal Vramp, causing the PWM signal S1 to be at a low level and thereby turning OFF switch Q1. Meanwhile, PWM signal S2, being the inverse of PWM signal S1, is at a high level, so switch Q2 is turned ON; PWM signal S3, being the inverse of PWM signal S2, is at a low level, so switch Q3 is turned OFF; and PWM signal S4, being the inverse of PWM signal S1, is at a high level, so switch Q4 is turned ON. Therefore, during the time interval from time point t1 to time point t2, switches Q2 and Q4 are ON, and switches Q1 and Q3 are OFF, such that the first terminal N1 of inductor L1 is electrically connected to the reference potential (which, in the present embodiment, is ground potential). The inductor L1 is demagnetized, the inductor current iL gradually decreases, and the first output current Iout1 also gradually decreases. In other words, during the time interval from time point t0 to time point t2, the first terminal N1 of the inductor L1 switches between half of the input voltage Vin and the reference potential.

At time point t2, the current sensing circuit 2132 detects that the inductor current iL has reached the zero current Izc and generates a zero current signal Szc. The logic control circuit 21331 terminates the first inductor cycle based on the zero current signal Szc. Between time point t2 and time point t3, the system enters a predefined dead time, during which the inductor current iL is maintained at zero current Izc. Subsequently, at time point t3, the second inductor cycle begins. It should be noted that the time interval from time point t0 to time point t3 constitutes a complete first inductor cycle, which includes the magnetization of inductor L1 (from the time point when the inductor current iL is at zero current Izc to the time point when the ramp signal Vramp exceeds the first error amplification signal Scom1), the demagnetization of inductor L1 (from the time point when the ramp signal Vramp exceeds the first error amplification signal Scom1 to the time point when the inductor current iL returns to zero current Izc), and the predefined dead time.

Between time point t3 and time point t6, the hybrid switching converter with a single inductor and multiple outputs operates in the second inductor cycle. During this period, the time-division switch control signal Sab controls the time-division switch SWab, for example, to a low logic level, such that the second error amplifier EA2 is electrically connected to the comparator CP. The first time-division signal S5 turns OFF the first output switch Q5, and the second time-division signal S6 turns ON the second output switch Q6. During the period from time point t3 to time point t4, the second error amplification signal Scom2 is higher than the ramp signal Vramp, causing PWM signal S1 to be at a high level, thereby turning ON switch Q1. Meanwhile, PWM signal S2, being the inverse of PWM signal S1, is at a low level, so switch Q2 is OFF; PWM signal S3, being the inverse of PWM signal S2, is at a high level, so switch Q3 is ON; and PWM signal S4, being the inverse of PWM signal S1, is at a low level, so switch Q4 is OFF. Therefore, during the period from time point t3 to time point t4, switches Q1 and Q3 are ON, and switches Q2 and Q4 are OFF, such that capacitors C1 and C2 are connected in series between the input voltage Vin and ground. At this time, capacitor C1 is charged, and the voltage at the first terminal N1 of inductor L1 is half the input voltage Vin (i.e., the difference between Vin and the voltage across capacitor C1: Vin−Vin/2). The inductor L1 is magnetized, the inductor current iL increases gradually, and the second output current Iout2 also increases accordingly.

During the period from time point t4 to time point t5, the second error amplification signal Scom2 is lower than the ramp signal Vramp, and the PWM signal S1 is at a low level, thereby turning OFF switch Q1. Meanwhile, PWM signal S2, being the inverse of PWM signal S1, is at a high level, so switch Q2 is ON; PWM signal S3, being the inverse of PWM signal S2, is at a low level, so switch Q3 is OFF; and PWM signal S4, being the inverse of PWM signal S1, is at a high level, so switch Q4 is ON. Therefore, during the period from time point t4 to time point t5, switches Q2 and Q4 are ON, and switches Q1 and Q3 are OFF, such that the first terminal N1 of inductor L1 is connected to a reference potential (which is ground in this embodiment), and the inductor L1 is demagnetized. The inductor current iL decreases gradually, and the second output current Iout2 also decreases accordingly. In other words, during the period from time point t3 to time point t5, the first terminal N1 of inductor L1 switches between half the input voltage Vin and the reference potential.

At time point t5, the current sensing circuit 2132 detects that the inductor current iL has reached a zero current Izc and generates a zero current signal Szc. The logic control circuit 21331 terminates the second inductor cycle based on the zero current signal Szc. Between time point t5 and time point t6, the system enters a preset dead time, during which the inductor current iL is maintained at the zero current Izc. Subsequently, at time point t6, another first inductor cycle begins. It should be noted that, between time point t3 and time point t6, a complete cycle of inductor L1 operation is performed, including magnetization (from the moment the inductor current iL reaches zero current Izc to the point when the ramp signal Vramp exceeds the second error amplification signal Scom2) and demagnetization (from the moment the ramp signal Vramp exceeds the second error amplification signal Scom2 to the point when the inductor current iL reaches zero current Izc), along with the preset dead time. This defines one second inductor cycle.

In the present embodiment, the first capacitor C1 is charged and discharged within a single first inductor cycle (e.g., from time point t0 to time point t3), thereby achieving a balanced state to ensure stable operation. On the other hand, the first capacitor C1 is also charged and discharged within a single second inductor cycle (e.g., from time point t3 to time point t6), thereby achieving a balanced state to ensure stable operation.

In this embodiment, the initial point of the ramp signal Vramp is triggered at the end of each first inductor cycle and each second inductor cycle.

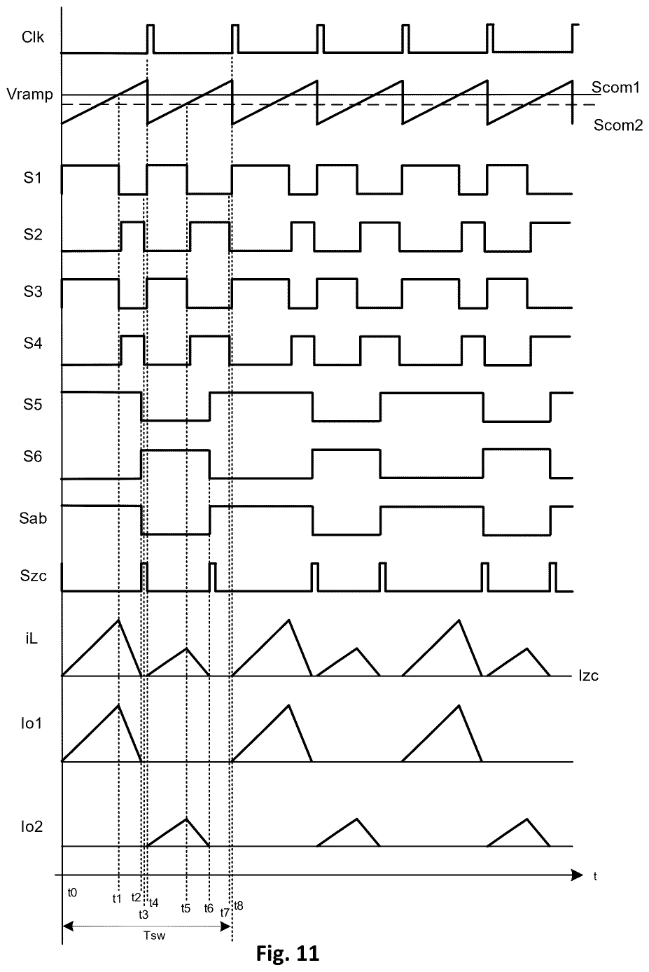

FIG. 11 is a signal waveform diagram illustrating signals related to the hybrid switching converter with a single inductor and multiple outputs according to one embodiment of the present invention. This embodiment takes a periodically repeated first inductor cycle and second inductor cycle as an example, where time points t0 to t8 represent one unit cycle Tsw, which includes one first inductor cycle and one second inductor cycle. During each first inductor cycle, the hybrid switching converter with a single inductor and multiple outputs operates in a boundary conduction mode (BCM). Unlike the embodiment shown in FIG. 10, in this embodiment, each second inductor cycle operates in a discontinuous conduction mode (DCM). The differences from FIG. 10 are described below.

In this embodiment, at time point t6, the current sensing circuit 2132 detects that the inductor current iL reaches zero current Izc and generates a zero current signal Szc. However, the logic control circuit 21331 terminates the second inductor cycle based on the clock signal Clk instead of the zero current signal Szc. Therefore, the dead time from time point t6 to time point t8 is longer than the preset dead time shown in the embodiment of FIG. 10, and during this dead time, the inductor current iL remains at zero current Izc. The other parts (i.e., from t0 to t3, t3 to t5, and t7 to t8) are the same as in the embodiment shown in FIG. 10 and are not repeated here.

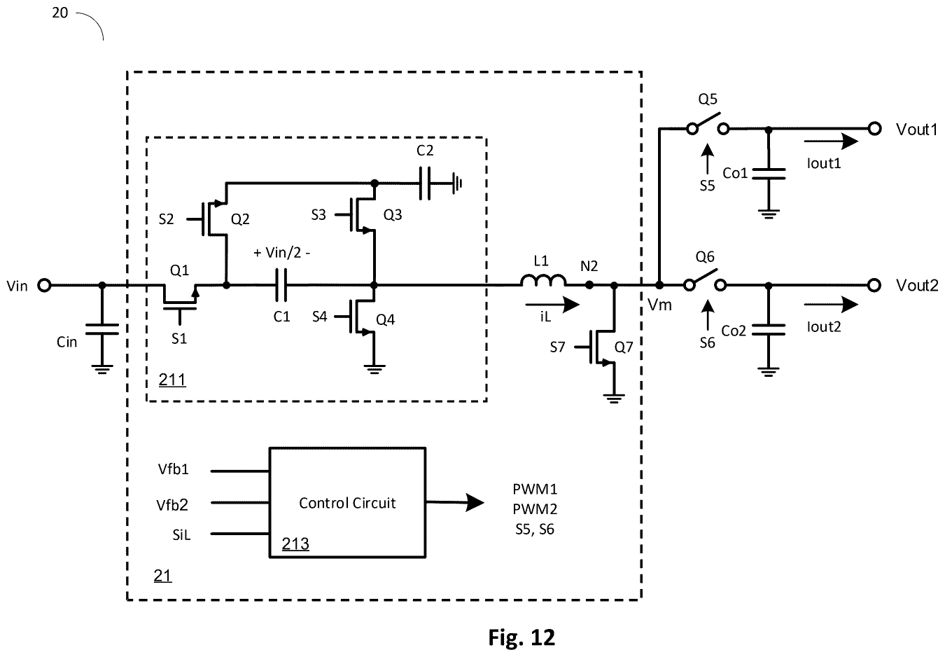

FIG. 12 shows a schematic diagram of another more specific embodiment of the sub-switching converter 21 in the hybrid switching converter 20 with a single inductor and multiple outputs shown in FIGS. 2A-2D. Unlike the embodiment shown in FIG. 3, in this embodiment, the sub-switching converter 21 further includes a boost switch Q7 coupled between the second terminal N2 of the inductor L1 and a reference potential (which is ground in this embodiment), allowing the hybrid switching converter 20 to operate in either a boost or buck mode based on whether the first target voltage or the second target voltage is higher than the input voltage Vin.

The boost switch Q7 provides flexibility for the hybrid switching converter 20 with a single inductor to accommodate different target voltage requirements. For example, when the first or second target voltage is higher than the input voltage Vin, the boost switch Q7 is switched along with the first output switch Q5 or second output switch Q6 to achieve boost power conversion. In other words, the switched-capacitor voltage dividing circuit 211, the inductor L1, and the boost switch Q7 are configured in a boost topology. In this topology, the first terminal N1 of the inductor L1 may be electrically connected to the input voltage Vin, allowing energy stored in inductor L1 to be released to the output node to increase the first output voltage Vout1 or second output voltage Vout2 to the target value.

On the other hand, when the first or second target voltage is lower than the input voltage Vin, the boost switch Q7 is turned off, and the switched-capacitor voltage dividing circuit 211 and the inductor L1 are directly configured in a buck topology. In this topology, inductor L1 cooperates with the switched-capacitor voltage dividing circuit 211 to reduce the input voltage Vin, thereby providing a stable target voltage lower than Vin.

In one embodiment, the first terminal N1 of the inductor L1 can be electrically connected to half the input voltage Vin through switched-capacitor conversion. Then, with switching between the boost switch Q7 and the first or second output switch Q5 or Q6, boost conversion can be performed from half the input voltage Vin.

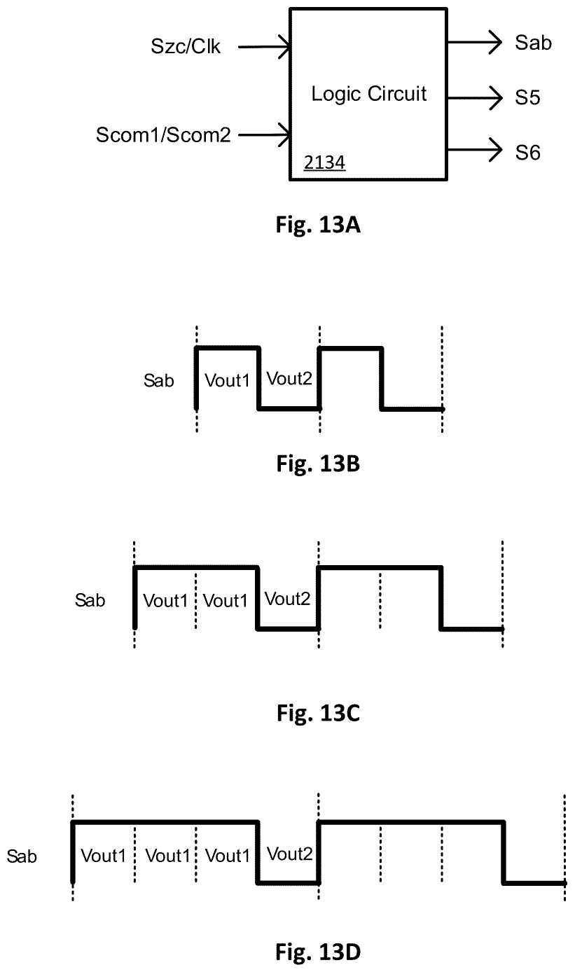

FIG. 13A shows a schematic diagram of a logic circuit according to one embodiment of the present invention. FIGS. 13B-13D illustrate waveforms of the time-division switching control signal Sab in both normal mode and skip mode. As shown in FIG. 13A, the logic circuit 2134 of the control circuit 213 is configured to generate the time-division switching control signal Sab, first time-division signal S5, and second time-division signal S6 based on the first error amplification signal Scom1, the second error amplification signal Scom2, and the clock signal Clk or the zero current signal Szc. Both the time-division switching control signal Sab and the time-division signals S5, S6 are triggered by the clock signal Clk or zero current signal Szc. The signals S5 and S6 are complementary to each other, and Sab is synchronized with S5. Compared with the logic circuit 2134 shown in FIG. 8, the logic circuit in FIG. 13A further determines whether the hybrid switching converter 20 enters skip mode based on the voltage difference between Scom1 and Scom2. In skip mode, the difference in the number of first and second inductor cycles within one unit cycle is positively correlated with the difference between the first and second output currents Iout1 and Iout2. In one embodiment, particularly under BCM and DCM, the voltage difference between Scom1 and Scom2 is positively correlated with the difference in output currents Iout1 and Iout2.

FIG. 13B shows a waveform diagram of the time-division switching control signal Sab in normal mode operation of the hybrid switching converter with a single inductor and multiple outputs according to one embodiment of the present invention. In this embodiment, when operating in normal mode, the time-division switching control signal Sab alternately changes between logic high and logic low levels between the first output (which generates the first output voltage Vout1) and the second output (which generates the second output voltage Vout2). This causes the two output terminals to sequentially generate stable and continuous waveforms to meet load demands and ensure system stability. The waveform in FIG. 13B illustrates this, showing alternating high and low logic levels within a fixed period.

In one embodiment, when both the first output load (corresponding to Vout1 and Iout1) and the second output load (corresponding to Vout2 and Iout2) are not in a light load condition and their difference is less than a load threshold—for example, when the difference between Scom1 and Scom2 is less than a certain threshold—the logic circuit 2134 periodically alternates the first and second time-division signals S5 and S6 to the enabled logic level, such that the hybrid switching converter with a single inductor and multiple outputs operates in normal mode. For example, in the embodiment shown in FIG. 10, this corresponds to periodically repeating two consecutive first inductor cycles followed by two consecutive second inductor cycles.

FIG. 13C is a schematic diagram illustrating a time-division switching control signal Sab of the hybrid switching converter with a single inductor and multiple outputs operating in one type of skip mode according to one embodiment of the present invention. FIG. 13D is a schematic diagram illustrating the time-division switching control signal Sab of the hybrid switching converter operating in another type of skip mode according to one embodiment of the present invention. For example, when the converter detects that the difference between the first error amplification signal Scom1 and the second error amplification signal Scom2 exceeds a predetermined first threshold, the logic circuit 2134 activates skip mode. As shown in the signal waveform in FIG. 13C, one high-level pulse of the second time-division signal S6 is skipped in each unit cycle Tsw. In one embodiment, this corresponds to skipping two consecutive second inductor cycles in each unit cycle Tsw, i.e., periodically repeating four consecutive first inductor cycles followed by two consecutive second inductor cycles.

When the difference between the first error amplification signal Scom1 and the second error amplification signal Scom2 continues to increase and remains above a predetermined second threshold (which is higher than the first threshold) for a preset period, the logic circuit 2134 dynamically adjusts the duty ratio of the high and low levels of the time-division switching control signal Sab based on the variation in the signal difference. Specifically, as the difference between Scom1 and Scom2 continues to increase, the duration or proportion of the logic high level in the time-division switching control signal Sab gradually increases, while the proportion of the logic low level decreases accordingly. As shown in FIG. 13D, two high-level pulses of the second time-division signal S6 are skipped in each unit cycle Tsw. In one embodiment, this corresponds to skipping four second inductor cycles in each unit cycle Tsw, i.e., periodically repeating six consecutive first inductor cycles followed by two consecutive second inductor cycles.

This adjustment mechanism is referred to as skip mode. It functions to reduce the switching frequency during light load conditions on one of the outputs by intentionally skipping certain switching cycles, thereby reducing energy loss and electromagnetic interference (EMI) caused by frequent switching, while still maintaining basic control of the output voltage.

Of course, when both the first and second output loads are under light load conditions, the logic circuit 2134 may also skip at least one high-level pulse of the first time-division signal S5 and at least one high-level pulse of the second time-division signal S6 in each unit cycle Tsw.

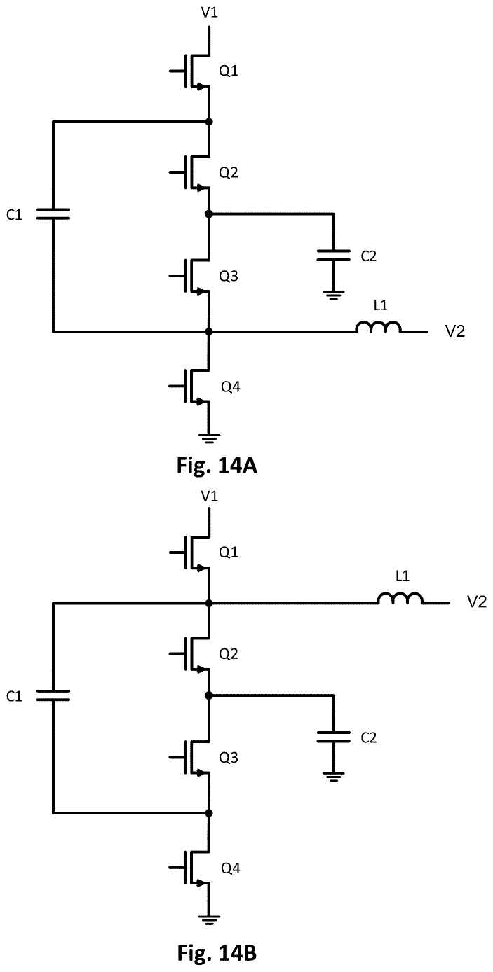

FIGS. 14A and 14B respectively illustrate schematic diagrams of a more specific embodiment of the first configuration and the second configuration of the switched-capacitor voltage dividing circuit. Referring to FIGS. 2C and 2D, FIG. 14A corresponds to the first configuration where the common node G is electrically connected to node D2, as depicted in FIGS. 2C and 2D. Similarly, FIG. 14B corresponds to the second configuration where the common node G is electrically connected to node D1, as shown in FIGS. 2C and 2D.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, the second configuration of the switched-capacitor voltage dividing circuit shown in FIG. 14B may be applied to the hybrid switching converter 20 with a single inductor and multiple outputs illustrated in FIGS. 3, 4, 5, 7, and 12. For another example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A hybrid switching converter with a single inductor and multiple outputs for converting an input voltage to a first output voltage and a second output voltage, comprising:
a sub-switching converter configured to convert the input voltage to an intermediate voltage;
a first output switch configured to conduct during a first inductor cycle according to a first time-division signal, to convert the intermediate voltage to the first output voltage; and
a second output switch configured to conduct during a second inductor cycle according to a second time-division signal, to convert the intermediate voltage to the second output voltage;
wherein the sub-switching converter comprises:
a switched-capacitor voltage dividing circuit, configured to perform switched-capacitor operation during the first inductor cycle by controlling a plurality of switches according to a first set of pulse-width modulation (PWM) signals, converting a first voltage to a first set voltage having two different voltage levels, and configured to perform switched-capacitor operation during the second inductor cycle by controlling the plurality of switches according to a second set of PWM signals, converting the first voltage to a second set voltage having two different voltage levels;
an inductor having a first terminal coupled to the switched-capacitor voltage dividing circuit and a second terminal coupled to a second voltage, wherein, during the first inductor cycle, the first terminal of the inductor switches between the two different voltage levels of the first set voltage according to the first set of PWM signals, and during the second inductor cycle, the first terminal of the inductor switches between the two different voltage levels of the second set voltage according to the second set of PWM signals; and
a control circuit configured to generate the first set of PWM signals, the second set of PWM signals, and the first time-division signal and the second time-division signal, to time-divisionally control the plurality of switches, the first output switch, and the second output switch, to periodically magnetize and demagnetize the same inductor during the first inductor cycle and the second inductor cycle, to perform power conversion between the first voltage and the second voltage, and to generate the first output voltage and second output voltage periodically corresponding to the first inductor cycle and second inductor cycle;
wherein the first voltage and the second voltage respectively correspond to one of the input voltage and the intermediate voltage;
wherein the control circuit is further configured to regulate the first output voltage to a first target voltage based on a first feedback signal related to the first output voltage during the first inductor cycle, and regulate the second output voltage to a second target voltage based on a second feedback signal related to the second output voltage during the second inductor cycle;
wherein the hybrid switching converter with a single inductor and multiple outputs operates in a boundary conduction mode (BCM) or a discontinuous conduction mode (DCM) during the first and second inductor cycles;
wherein a first configuration of the sub-switching converter refers to the inductor being coupled to a negative terminal of a first capacitor of the switched-capacitor voltage dividing circuit, and a second configuration refers to the inductor being coupled to a positive terminal of the first capacitor;
wherein, in the first configuration, the sub-switching converter converts the first voltage to two different voltage levels including half the first voltage and a reference potential, and in the second configuration, the sub-switching converter converts the first voltage to two different voltage levels comprising the first voltage and half the first voltage;
wherein, during a charging phase, the first capacitor of the switched-capacitor voltage dividing circuit is coupled in series with a second capacitor between the first voltage and the reference potential, and during a discharging phase, the first capacitor is coupled in parallel with the second capacitor to the reference potential.

2. The hybrid switching converter with a single inductor and multiple outputs of claim 1, wherein the switched-capacitor voltage dividing circuit reaches a capacitor balance state in each first inductor cycle and each second inductor cycle.

3. The hybrid switching converter with a single inductor and multiple outputs of claim 1, wherein the control circuit comprises:
a first error amplifier configured to amplify a difference between the first feedback signal and a first reference signal to generate a first error amplification signal;
a second error amplifier configured to amplify a difference between the second feedback signal and a second reference signal to generate a second error amplification signal; and
a modulation circuit configured to generate the first set of PWM signals according to the first error amplification signal during the first inductor cycle, and generate the second set of PWM signals according to the second error amplification signal during the second inductor cycle.

4. The hybrid switching converter with a single inductor and multiple outputs of claim 3, wherein the control circuit further comprises a current sensing circuit configured to sense an inductor current to generate an inductor current signal, and the modulation circuit is further configured to generate the first set of PWM signals and the second set of PWM signals according to the inductor current signal.

5. The hybrid switching converter with a single inductor and multiple outputs of claim 4, wherein the current sensing circuit is further configured to generate a zero current signal when the inductor current reaches a zero current;
wherein the control circuit further comprises a logic circuit configured to generate the first time-division signal and the second time-division signal according to the zero current signal.

6. The hybrid switching converter with a single inductor and multiple outputs of claim 3, wherein the control circuit further comprises a logic circuit configured to generate the first time-division signal and the second time-division signal according to a clock signal.

7. The hybrid switching converter with a single inductor and multiple outputs of claim 3, wherein the control circuit further comprises a logic circuit configured to generate a time-division switch control signal, the first time-division signal, and the second time-division signal according to the first error amplification signal, the second error amplification signal, and a clock signal or a zero current signal;
wherein the time-division switch control signal, the first time-division signal, and the second time-division signal are triggered by the clock signal or the zero current signal, and the first time-division signal and the second time-division signal are complementary to each other;
wherein the logic circuit is further configured to determine whether the hybrid switching converter with a single inductor and multiple outputs enters a skip mode according to a difference between a first output current and a second output current;
wherein, in the skip mode, a difference in a number of occurrences of the first inductor cycle and the second inductor cycle within a unit cycle is positively correlated with the difference between the first output current and the second output current.

8. The hybrid switching converter with a single inductor and multiple outputs of claim 4, wherein the current sensing circuit comprises a sensing resistor and a sensing capacitor connected in series and coupled to the inductor, and the inductor current is sensed based on a voltage across the sensing capacitor to generate the inductor current signal, wherein a time constant of the sensing resistor and the sensing capacitor matches a time constant of the inductor and a DC resistance of the inductor.

9. The hybrid switching converter with a single inductor and multiple outputs of claim 1, wherein the power conversion between the first voltage and the second voltage is a boost conversion or a buck conversion.

10. The hybrid switching converter with a single inductor and multiple outputs of claim 1, wherein when the switched-capacitor voltage dividing circuit and the inductor are configured in a buck configuration, the sub-switching converter further comprises a boost switch coupled between the second terminal of the inductor and the reference potential, such that the hybrid switching converter with a single inductor and multiple outputs operates in either a boost conversion or a buck conversion according to the first target voltage or the second target voltage.

11. The hybrid switching converter with a single inductor and multiple outputs of claim 1, wherein the first set of PWM signals determines a duty ratio of switching between the two different voltage levels of the first set voltage at the first terminal of the inductor, and the second set of PWM signals determines a duty ratio of switching between the two different voltage levels of the second set voltage at the first terminal of the inductor.

12. The hybrid switching converter with a single inductor and multiple outputs of claim 5, wherein an initial point of a ramp signal is triggered at an end of each first inductor cycle, and another initial point of the ramp signal is triggered at an end of each second inductor cycle;
wherein the modulation circuit compares the ramp signal with the first error amplification signal during the first inductor cycle to generate the first set of PWM signals;
wherein the modulation circuit compares the ramp signal with the second error amplification signal during the second inductor cycle to generate the second set of PWM signals;
wherein the first inductor cycle and the second inductor cycle are arranged alternately and repeated periodically in sequence.

13. A control method for a hybrid switching converter with a single inductor and multiple outputs, comprising:
converting an input voltage to an intermediate voltage;
conducting a first output switch during a first inductor cycle according to a first time-division signal to convert the intermediate voltage to a first output voltage; and
conducting a second output switch during a second inductor cycle according to a second time-division signal to convert the intermediate voltage to a second output voltage;
wherein converting the input voltage to the intermediate voltage comprises:
performing a switched-capacitor operation during the first inductor cycle by controlling a plurality of switches according to a first set of pulse-width modulation (PWM) signals to convert a first voltage to a first set voltage having two different voltage levels, and performing a switched-capacitor operation during the second inductor cycle by controlling the plurality of switches according to a second set of PWM signals to convert the first voltage to a second set voltage having two different voltage levels;
switching a first terminal of an inductor between the two different voltage levels of the first set voltage during the first inductor cycle according to the first set of PWM signals;
switching the first terminal of the inductor between the two different voltage levels of the second set voltage during the second inductor cycle according to the second set of PWM signals;
coupling the first terminal of the inductor to a negative terminal of a first capacitor to form a first configuration and converting the first voltage to two different voltage levels including half the first voltage and a reference potential during the first inductor cycle or the second inductor cycle;
coupling the first terminal of the inductor to a positive terminal of the first capacitor to form a second configuration and converting the first voltage to two different voltage levels comprising the first voltage and half the first voltage during the first inductor cycle or the second inductor cycle;
during a charging phase, coupling the first capacitor in series with a second capacitor between the first voltage and the reference potential to store charge;
during a discharging phase, coupling the first capacitor in parallel with the second capacitor to the reference potential to release charge;
time-divisionally controlling the plurality of switches using the first set of PWM signals and the second set of PWM signals to periodically magnetize and demagnetize the same inductor during the first inductor cycle and the second inductor cycle for performing power conversion between the first voltage and a second voltage;
wherein the first voltage and the second voltage respectively correspond to one of the input voltage and the intermediate voltage;
time-divisionally controlling the first output switch and the second output switch using the first time-division signal and the second time-division signal to periodically generate the first output voltage and the second output voltage corresponding to the first inductor cycle and the second inductor cycle; and
regulating the first output voltage to a first target voltage based on a first feedback signal related to the first output voltage during the first inductor cycle, and regulating the second output voltage to a second target voltage based on a second feedback signal related to the second output voltage during the second inductor cycle;
wherein the hybrid switching converter with a single inductor and multiple outputs operates in a boundary conduction mode (BCM) or a discontinuous conduction mode (DCM) during the first inductor cycle and the second inductor cycle.

14. The control method of claim 13, wherein a capacitor balance state is reached in each first inductor cycle and each second inductor cycle.

15. The control method of claim 13, wherein the step of time-divisionally controlling the plurality of switches, the first output switch, and the second output switch to periodically magnetize and demagnetize the same inductor during the first inductor cycle and the second inductor cycle for power conversion between the first voltage and the second voltage comprises:
amplifying a difference between the first feedback signal and a first reference signal to generate a first error amplification signal;
amplifying a difference between the second feedback signal and a second reference signal to generate a second error amplification signal; and
generating the first set of PWM signals according to the first error amplification signal during the first inductor cycle, and generating the second set of PWM signals according to the second error amplification signal during the second inductor cycle.

16. The control method of claim 15, wherein the step of time-divisionally controlling the plurality of switches, the first output switch, and the second output switch to periodically magnetize and demagnetize the same inductor during the first inductor cycle and the second inductor cycle for power conversion between the first voltage and the second voltage further comprises sensing an inductor current to generate an inductor current signal, and further generating the first set of PWM signals and the second set of PWM signals according to the inductor current signal.

17. The control method of claim 16, wherein the step of time-divisionally controlling the plurality of switches, the first output switch, and the second output switch to periodically magnetize and demagnetize the same inductor during the first inductor cycle and the second inductor cycle for power conversion between the first voltage and the second voltage further comprises:
generating a zero current signal when the inductor current is zero based on the inductor current signal; and
generating the first time-division signal and the second time-division signal based on the zero current signal.

18. The control method of claim 15, wherein the step of time-divisionally controlling the plurality of switches, the first output switch, and the second output switch to periodically magnetize and demagnetize the same inductor during the first inductor cycle and the second inductor cycle for power conversion between the first voltage and the second voltage further comprises generating the first time-division signal and the second time-division signal based on a clock signal.

19. The control method of claim 15, wherein the step of time-divisionally controlling the plurality of switches, the first output switch, and the second output switch to periodically magnetize and demagnetize the same inductor during the first inductor cycle and the second inductor cycle for power conversion between the first voltage and the second voltage further comprises:
generating a time-division switch control signal, the first time-division signal, and the second time-division signal based on the first error amplification signal, the second error amplification signal, and a clock signal or a zero current signal;
determining whether the hybrid switching converter with a single inductor and multiple outputs enters a skip mode based on a voltage difference between the first error amplification signal and the second error amplification signal;
wherein the time-division switch control signal, the first time-division signal, and the second time-division signal are triggered by the clock signal or the zero current signal, and the first time-division signal and the second time-division signal are complementary to each other;
wherein, in the skip mode, a difference in a number of occurrences of the first inductor cycle and the second inductor cycle within a unit cycle is positively correlated with a difference between a first output current and a second output current.

20. The control method of claim 16, wherein the step of sensing the inductor current to generate the inductor current signal comprises:
providing a sensing resistor and a sensing capacitor connected in series and coupled to the inductor, sensing the inductor current based on a voltage across the sensing capacitor to generate the inductor current signal, wherein a time constant of the sensing resistor and the sensing capacitor matches a time constant of the inductor and a DC resistance of the inductor.

21. The control method of claim 13, wherein the power conversion between the first voltage and the second voltage is a boost conversion or a buck conversion.

22. The control method of claim 13, wherein the first set of PWM signals determines a duty ratio of switching the first terminal of the inductor between the two different voltage levels of the first set voltage, and the second set of PWM signals determines a duty ratio of switching the first terminal of the inductor between the two different voltage levels of the second set voltage.

23. The control method of claim 17, wherein an initial point of a ramp signal is triggered at an end of each first inductor cycle, and another initial point of the ramp signal is triggered at an end of each second inductor cycle;
wherein the first set of PWM signals are generated by comparing the ramp signal with the first error amplification signal during the first inductor cycle;
wherein the second set of PWM signals are generated by comparing the ramp signal with the second error amplification signal during the second inductor cycle;
wherein the first inductor cycle and the second inductor cycle are alternately arranged and repeatedly performed in sequence.
